(19) United States
(12) Patent Application Publication
(10) Pub. No.: US 2024/0406309 A1
(43) Pub. Date: Dec. 5, 2024

(54) PROCESSING COMMUNICATIONS FOR LAW ENFORCEMENT

(71) Applicants: Jakub Misiorny, London (GB); Kamila Hankiewicz, London (GB)

(72) Inventors: Jakub Misiorny, London (GB); Kamila Hankiewicz, London (GB)

(21) Appl. No.: 18/673,382

(22) Filed: May 24, 2024

(30) Foreign Application Priority Data
May 30, 2023 (GB) 2308022.9

(51) Int. Cl. H04M 3/22; G06F 40/35

(52) U.S. Cl. CPC H04M 3/2281; G06F 40/35

(57) ABSTRACT

A computer implemented method of processing a communication to a law enforcement service, the method comprising: receiving a communication transcript of the communication; analysing the communication transcript to identify communication key information; determining communication intelligence data based on the communication key information; and outputting the communication intelligence data.

### BACKGROUND OF THE INVENTION

The present disclosure relates to a system and method for processing a communication to a law enforcement service.

Incoming communications, such as audio communications (or calls), to emergency services can be frantic and time-critical. An emergency communication handler may have to work at speed and under emotional stress to process the call and determine and initiate the best course of action.

The disclosed systems and methods provide an improved way of processing communications to emergency services.

### SUMMARY OF THE INVENTION

According to a first aspect of the present disclosure there is provided a computer implemented method of processing a communication to an emergency service, the method comprising:
(a) receiving a communication transcript of the communication;
(b) analysing the communication transcript to identify communication key information;
(c) determining communication intelligence data based on the communication key information; and
(d) outputting the communication intelligence data.

The communication may comprise an audio communication. The method may comprise:
(a) receiving an audio signal of the audio communication; and
(b) processing the audio signal with a speech-to-text model to generate the communication transcript.

The speech to text model may comprise an artificial intelligence model.

The speech to text model may comprise an artificial intelligence model trained using historical data comprising audio communications to one or more emergency services and corresponding communication transcripts.

The method may comprise processing the audio signal with a speech-to-text model to generate a communication transcript comprising one or more non-verbal indicators.

The one or more non-verbal indicators comprise one or more of: stress; fear; nervousness; intoxication; dishonesty; and duress of a voice in the audio communication and/or background noise in the audio communication.

The method may comprise:
(a) outputting the communication transcript as part of the communication intelligence data; and
(b) receiving corrections to the communication transcript to generate a corrected communication transcript; and
(c) updating the speech-to-text model using the corrected communication transcript.

The communication may comprise a non-audio communication. The non-audio communication may comprise: a text based message from a mobile device or online messaging service; data entered on an online form; or a tagged post on social media.

The communication intelligence data may comprise a threat grade.

The method may comprise determining the threat grade using a rules based model. The method may comprise determining the threat grade using a machine learning model.

The communication key information may comprise one or more danger phrases and the method comprises determining the threat grade based on the one or more danger phrases.

The communication key information may comprise one or more entity identifiers.

The one or more entity identifiers may include one or more of: an entity name; an entity address; an entity date of birth; an entity ethnicity; an entity nationality; an entity gender; an entity age; an entity relationship to another entity; an entity health status; an entity appearance description; an entity victim status; and an entity registration.

The method may comprise: identifying one or more relationships between elements of the communication key information; and determining the communication intelligence data based on the communication key information and the one or more identified relationships.

The one or more relationships may comprise:
(a) a relationship between a plurality of entity identifiers;
(b) a relationship between a plurality of entities; or
(c) a relationship between an entity identifier and one or more danger phrases.

Analysing the communication transcript may comprise processing the communication transcript with a natural language processing model.

The natural language processing model may be trained using a training data set comprising a plurality of annotated transcripts of communications to emergency services.

The method may comprise:
(a) outputting the communication key information as an annotated communication transcript;
(b) receiving corrections to the annotated communication transcript to generate a corrected annotated communication transcript; and
(c) updating the natural language processing model using the corrected annotated communication transcript.

The communication key information may comprise one or more entity identifiers and the method may comprise:
(a) searching one or more data sources and acquiring record data associated with the one or more entity identifiers; and
(b) determining the communication intelligence data based on the communication key information and the record data.

The communication intelligence data may comprise a threat grade. The method may comprise determining the threat grade based on the communication key information and the record data.

The one or more data sources may comprise one or more of:
(a) one or more databases;
(b) one or more other communications to emergency services; and
(c) one or more publicly available data sources comprising news websites, social media posts or social media profiles.

The one or more data sources may comprise a plurality of heterogenous data sources. The method may comprise merging heterogenous source data to provide the record data associated with the one or more entity identifiers.

The method may comprise associating the one or more entity identifiers with the record data using one or more matching models.

The one or more matching models may utilise normalization, look-ups, vectorization, and/or embedding techniques to disambiguate an entity.

The communication intelligence data may comprise one or more of: the communication transcript; the annotated communication transcript; the communication key information; the one or more entity identifiers; one or more entities associated with the one or more entity identifiers; the one or more danger phrases; the one or more identified relationships between the communication key information; the record data/collated entity information; and the threat grade.

The method may comprise outputting the communication intelligence data to one or more of:
(a) a data source or database;
(b) an operator user interface;
(c) a regulatory module for performing an administrative action.

The emergency service may comprise a law enforcement service, an ambulance service or a fire service.

According to a second aspect of the present disclosure there is provided an apparatus comprising:
(a) one or more processors; and
(b) memory storing instructions that when executed by the one or more processors, cause the one or more processors to perform any method disclosed herein.

A non-transitory, computer-readable storage medium storing instructions that when executed by one or more processors, cause the one or more processors to perform any method disclosed herein.

There may be provided a computer program, which when run on a computer, causes the computer to configure any apparatus, including a circuit, controller, processor, or device disclosed herein or perform any method disclosed herein. The computer program may be a software implementation, and the computer may be considered as any appropriate hardware, including a digital signal processor, a microcontroller, and an implementation in read only memory (ROM), erasable programmable read only memory (EPROM) or electronically erasable programmable read only memory (EEPROM), as non-limiting examples. The software may be an assembly program.

The computer program may be provided on a computer readable medium, which may be a physical computer readable medium such as a disc or a memory device, or may be embodied as a transient signal. Such a transient signal may be a network download, including an internet download. There may be provided one or more non-transitory computer-readable storage media storing computer-executable instructions that, when executed by a computing system, causes the computing system to perform any method disclosed herein.

### BRIEF DESCRIPTION OF DRAWINGS

One or more embodiments will now be described by way of example only with reference to the accompanying drawings in which:

FIG. 1 provides a generic overview of a communication processing approach according to embodiments of the present disclosure;

FIG. 2 illustrates a computer-implemented method of processing a communication to an emergency service according to an embodiment of the present disclosure;

FIG. 3 provides a structural overview of the data flow in an example method of audio communication processing; and

FIG. 4 illustrates an example operator dashboard presenting communication intelligence data from an audio communication according to an embodiment of the present disclosure.

### DETAILED DESCRIPTION OF THE INVENTION

One of the challenges for operators handling incoming communications to emergency services is the inability to find, process and collate all of the relevant information that is available to the operators and downstream emergency service personnel from all of the available systems (e.g. police databases, health records).

For the specific example of audio communications to law enforcement/police in the USA, some of the challenges in the current way the FCR (Force Control Room) operates are:
a. Operators risk mishearing key information from vulnerable callers in chaotic environments.
b. Operators do not, and, as humans, cannot write down everything the caller is saying.
c. Operators can be influenced by the emotion of the caller, resulting in poor, subjective decision making and inappropriate action.
d. Some calls may have no meaningful trace. They are recorded only as a call with an attached phone number and a name in a Telephony System with no notes. There is no log in Command & Control/Computer Aided Dispatch software.
e. Some calls can have very long Command & Control/Computer Aided Dispatch logs. As a result they can be hard to parse for operators, especially in the time sensitive environment of an ongoing incident (this can be exacerbated by the slow Command & Control/Computer Aided Dispatch software),
f. Many calls have administrative work associated with them that needs to be carried out after the call. The administrative work often involves duplicating information that is already written down in the Command & Control/Computer Aided Dispatch log or the Telephony system notes.

Most communications also require an operator to manually look up information in external systems and databases, such as:
a. Command & Control/Computer Aided Dispatch Software (C&C/CAD)
b. Local Crime databases (DBs)
c. National Crime DBs (e.g. police national computer in UK)
d. Vulnerable people DBs
e. Safeguarding DBs
f. Record management systems (RMS)
g. Customer relationship management system (CRMs)
h. Map data

Some communications also have very specific actions and regulations associated with them. This requires operators to perform repetitive actions after each communication of a specific type. For example, a Domestic Violence (DV/DA) call in the USA requires the operator, amongst others to:
a. Record dependant persons, other persons, suspects, vehicles in a specific format in a system of record
b. Send an email to a Domestic Violence Advisor to inform them about the caller, along with the incident number
c. Fill in a vulnerability assessment framework

The issues of missed information, subjective decision making, burdensome administrative requirements and disparate data sources can be common to all emergency services in all jurisdictions. The disclosed systems and methods can overcome one or more of the identified issues.

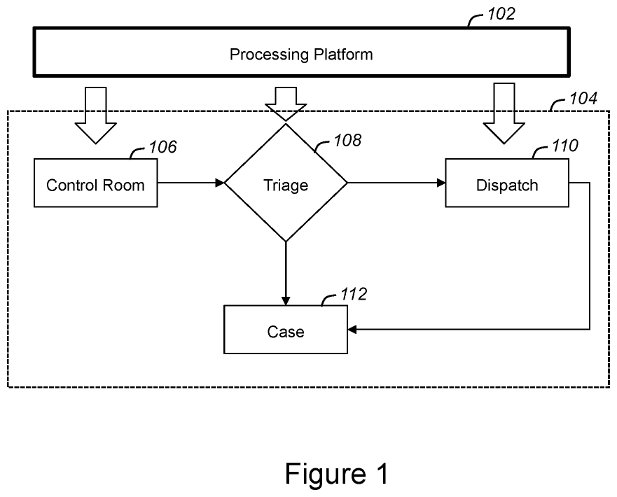

FIG. 1 provides a generic overview of the communication processing approach of the present disclosure. The disclosed systems and methods provide a processing platform 102 that integrates with, and improves, an existing emergency service communication handling architecture 104.

In this example, the existing communication handling architecture 104 represents a law enforcement architecture, specifically an FCR in the UK which is logically similar to an Control Room architecture in most US Police. The existing emergency service communication handling architecture 104 includes a control room 106 in which a call handling operator receives a communication such as an audio communication or call to the emergency service. The call handling operator processes the communication and forwards information from the call to a triage operator 108. The triage operator 108 may be the same operator as the call handling operator. The triage operator 108 may assess the call information and provide a course of action to a dispatch operator 110. The triage operator 108 may also input information to a case record 112. The dispatch operator 110 (who may be the same operator as the triage operator or call handling operator) may dispatch one or more emergency service personnel for example to an incident scene. The dispatch operator may update the case record 112. Emergency service personnel may continue to also update the case record 112, for example inputting forensic data from the incident scene. The case record 112 may be fragmented over multiple data sources with elements duplicated over the multiple data sources. This presents an issue for the operators when trying to collate information for future communications.

The processing platform 102 can integrate with all aspects of the existing emergency service communication handling architecture 104 to: record and analyse information from the communication; cross-reference the communication with one or more data sources; provide intelligence data related to the communication to one or more of the operators; provide recommendations such as a triage or dispatch recommendation; and/or perform administrative tasks.

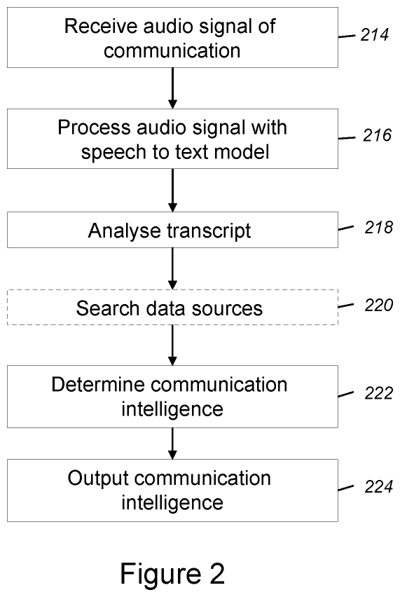

FIG. 2 illustrates a computer-implemented method of processing a communication to a law enforcement service according to an embodiment of the present disclosure.

In this example, the communication is an audio communication and a first step 214 comprises receiving an audio signal of the audio communication. The audio signal may comprise an analogue or digital representation of the audio communication. The audio communication may comprise a telephone call or the audio component of other forms of communication, for example a video call, a broadcast, CCTV recordings, a multimedia message etc. The audio communication may be a live communication or a recorded communication.

A second step 216 comprises processing the audio signal with a speech-to-text model to generate a communication transcript. The communication transcript may comprise a text file that transcribes speech from the audio communication.

A third step 218 comprises analysing the communication transcript to identify communication key information. The communication key information may include one or more entity identifiers (for example a name, age, date of birth etc. of a caller, a victim, a potential offender, an injured person etc. or a vehicle registration number or a location address).

A fourth optional step 220 comprises searching one or more data sources and acquiring record data associated with the communication key information. For example the method may comprise local law enforcement databases for criminal records relating to the one or more entity identifiers.

A fifth step 222 comprises determining communication intelligence data based on the communication key information and optionally the record data associated with the communication key information. The communication intelligence data may simply comprise the communication key information or may comprise enhanced information such as relationship mapping of the one or more entity identifiers, a calculated threat grade or cross-referenced information from the record data.

A sixth step 224 comprises outputting the communication intelligence data. The method may comprise outputting the communication intelligence data to an operator, an electronic device or a database.

Other examples may include non-audio communications to emergency services such as text based message from a mobile device or online messaging service, completion of an online form, a tagged post on social media, or other known text based communication. For such non-audio communications, the first step 214 and the second step 216 can be replaced by a step of receiving the communication transcript. Receiving the communication transcript may include receiving the text based communication.

Each of the above steps are discussed in further detail in relation to the specific example of law enforcement. However, it will be appreciated that the concepts described may be applied to other emergency services such as an ambulance service or a fire service.

### Receiving Audio Signal 214

The audio signal may be from a live audio communication or a recorded audio communication. The audio signal may comprise the same audio signal received by the call handling operator. The method may comprise receiving the audio signal and storing the audio signal in a local memory (e.g. a buffer) for processing. Such techniques are known and not described in detail here. In some examples, the method may comprise receiving the audio signal direct from a communication system, such as a telephone network or the internet. The audio signal may comprise an analogue communication signal and the method may comprise converting the analogue audio signal to a digital audio signal. Alternatively, the audio signal may comprise a digital signal received as voice over IP or via the internet. The method may comprise storing the digital audio signal in a digital audio file in a local memory for processing.

In some examples, the method may comprise receiving the audio signal as a digital file comprising an audio format (e.g., .MP3, .WAV etc.) The method may comprise receiving the digital file from memory storage, such as a local storage server or a networked storage server. The method may also comprise receiving the audio signal from a third-party recording software. The method may comprise receiving the digital file as part of a multimedia message provided over a messaging service.

### Processing Audio Signal 216

The method comprises processing the audio signal with a speech-to-text model to generate a communication transcript. The speech-to-text model can transcribe speech from one or more voices in the audio signal into text to provide the communication transcript.

The speech-to-text model may comprise an artificial intelligence (AI) model such as a machine learning model or a deep learning model. The speech-to-text model may comprise an artificial neural network.

The speech-to-text model may comprise a base speech-to-text AI model trained using training data comprising historical audio communications to a law enforcement service. The training data may comprise a training audio signal and a human generated transcription of speech in the training audio signal. Such training can tune the speech-to-text model for regional accents and vocabulary which can be prominent in emergency calls and critical to interpretation. The training data may also be annotated to indicate non-verbal signals, for example, stress, fear, nervousness, intoxication, dishonesty etc.) of the one or more individual voices in the audio signal or other non-verbal signals such as background noise which may provide useful evidence for an unknown location. As a result, the method may comprise processing the audio signal with the speech-to-text model to generate a communication transcript including one or more non-verbal indicators of one or more individual voices in the audio signal. The one or more non-verbal indicators may comprise one or more of: stress; fear; nervousness; intoxication; dishonesty; and duress.

In some examples the speech-to-text model may be updated incrementally using the communication transcript and user feedback (e.g. operator feedback). For example, the method may comprises outputting the communication transcript as part of the communication intelligence data and users (e.g. operators) may correct any perceived errors in the communication transcript. The method may comprise updating the speech-to-text model using the corrected communication transcript to enhance the speech-to-text model. The method may comprise incrementally updating the speech-to-text model based on individual corrected communication transcripts. Alternatively, the method may comprise periodically updating the speech-to-text model based on a batch of multiple corrected communication transcripts which have been stored in a server. In this way, the model updating can be performed offline and tested and validated before being implemented for live calls.

### Analysing Communication Transcript 218

The purpose of this call information analysis step is to extract the communication key information—the most important information from the communication.

The communication key information may include one or more entity identifiers. As described herein, the term “entity” may relate to a human individual. In some examples the term entity may also encompass a non-human legal entity or an asset such as a company, a building, a vehicle, etc. An entity identifier may be a characteristic of the entity that may aid identification of the entity. An entity identifier may comprise one or more of: an entity name; an entity address; an entity age; an entity date of birth; an entity ethnicity; an entity nationality; an entity gender; an entity relationship to another entity (e.g. brother, father, ex-wife); an entity health status; an entity appearance description; an entity victim status; and an entity registration (e.g. vehicle registration).

The communication key information may also include one or more danger words or danger phrases, for example, danger words may include any of: weapon, shooting, gun, rifle, knife, blade, attack, threat, rape, assault, danger, scared, injured, unconscious, critical, or other words or phrases that can indicate a person has been harmed or is at risk of harm. Danger phrases may include context or semantic information related to the danger word, for example the method may comprise identifying danger phrases that indicate whether a situation is ongoing or a future threat. For example, a danger phrase indicating a situation is ongoing could be “there has been a car accident and two people are unconscious,” whereas a phrase indicating a future threat may be “he said next time he would put me in hospital.”

The communication key information may also include an event type, e.g. an assault, a burglary, a road traffic accident, a protest etc.

The method may comprise processing the communication transcript with a natural language processing (NLP) model to identify the communication key information. The natural language processing model may be trained using a training data set comprising a plurality of annotated training transcripts of communications to law enforcement services. The annotated training transcripts may include one or more tags indicating the communication key information as identified and labelled by a human user.

The NLP model may include an entity recognition model trained on historical records. The historical records may include historical incident logs and case records from one or more data sources such as law enforcement databases (C&C/CAD software, National Crime Databeses, etc). In this way, the NLP model can identify one or more entities with an existing record in the data sources. In this way, the NLP model can also be used for the searching step described below.

The method may output the communication key information as part of the communication intelligence data. For example, the method may output the communication key information as an annotated communication transcript. In this way, the method can present the communication key information in a user-friendly interface. As users use the system, they can correct the results returned by it. For example, the users can mark-up text in the transcript and tag the text as a new entity (a person's name, or an address, etc), or edit entities already identified. Such annotation can help the operator manage the incident and generates invaluable data for training the models. Therefore, the method may comprise receiving corrections to the annotated communication transcript to generate a corrected annotated communication transcript; and updating the natural language processing model using the corrected annotated communication transcript. In this way, the NLP model can be re-trained using this data to produce continuously improving results.

### Searching Data Sources 220

Based on the communication key information extracted from the communication transcript in the previous step, the method may search for and surface relevant information from one or more data sources, for example from across the police's information landscape. The one or more data sources may include:
a. Local Police information systems, like Command & Control/Computer Aided Dispatch system, Local Safeguarding Databases, etc.
b. State, Federal and National Crime Databases.
c. Other communications/calls or their corresponding transcript and communication key information.
d. Publicly available data such as news websites, social media posts and social media profiles.

The method may use one or more entity identifiers from the communication key information as a search term for searching the one or more data sources. For example, the method may search social media to obtain a suspect's social media profile(s). The method may comprise diagnosing or gaining a wider understanding of a large incident (e.g. a terror incident) by cross-referencing the communication key information from the current communication with: (i) communication key information or communication intelligence data from other communications; and/or (ii) publicly available data on news websites and social media. For example, the London Bridge terror incident resulted in hundreds of social media posts when the incident erupted and multiple simultaneous calls to the emergency services. The method can rapidly identify such large instances by cross-referencing multiple calls and social media posts simultaneously in a way that is not possible for individual call handlers of the existing emergency service communication handling architecture.

The method may comprise matching or associating record data from the one or more data sources with the communication key information, particularly the one or more entity identifiers. The matching or associating may use one or more data matching models. The one or more data matching models may collate or group entity information for a particular entity from the one or more data sources and match the collated entity information (which may also be referred to as record data) with one or more entity indicators of the communication key information. For example, the data matching model may match a date of birth and family name to the collated entity information. In this way, entity identifiers not present in the communication key information (first name, address etc.) may be obtained from the collated entity information.

The one or more data matching models may comprise a model trained to collate or group the entity information using annotated training data from the one or more data sources. Such an approach can help overcome the unstructured or semi-structured nature of some of the data sources (for example a user entered log).

The one or more data matching models may use one or more linguistic techniques including one or more of: normalisation, look-ups, vectorization, embedding and other linguistic techniques to generate entity signals that can disambiguate references to the same “logical entity.” For example, in a communication people might refer to someone as Jim, but that person's official name is James. Similarly the speech-to-text model may generate the name John, but the entity's name is Jon.

The one or more data matching models may use one or more of the above linguistic techniques prior to performing the search, e.g. when analysing the communication transcript in step 218. For example, when in the conversation a caller talks about Jim, and then they, say “his name is James Longbottom”, the one or more data matching models can infer from context that the mentions of Jim are actually about James Longbottom, and group those together into the logical entity “James Longbottom”. The method may then search the one or more data systems for James Longbottom (and optionally Jim Longbottom).

The one or more data matching models may also use the one or more linguistic techniques on data returned from the search to improve the collating of entity data and the matching to the entity identifiers. For example, if the method only identifies the entity identifier “Jim Longbottom”, the method can search for that identifier along with another entity identifier, such as an address in the communication transcript. The method may receive record data from the one or more data sources for the name “James Longbottom”. In this way, the one or more data matching models performs normalization on the results of the search.

The data matching models may directly compare the entity signals to the collated entity information from the one or more data sources. In some examples, the data matching model may include an additional machine learning (ML) model that can process an entity signal and collated entity information and output a probability that they refer to the same “logical entity”. The additional ML layer can take into account context (e.g., an immediate linguistic context of the conversation, the data source the information is from, etc). The ML (Machine Learning) layer can be updated and improved over time based on association corrections provided by a user (operator) of the system.

### Determining Communication Intelligence 222

In some examples, the method may comprise determining communication intelligence data by identifying one or more relationships between the communication key information. For example, the method may comprise associating one or more entity identifiers with the same entity, e.g. associating a first name, a second name and an address to the same person. As a second example, the method may comprise identifying a relationship between a first entity and a second entity, e.g. identifying a first person is a dependent of a second person. The method may also comprise associating an entity identifier with a danger phrase, for example identifying that there is an armed intruder in the property of the person making the call from the phrase “I can see them downstairs on the camera and they have a gun.”

In some examples, the method may comprise determining communication intelligence data comprising the collated entity information (record data) from the one or more data sources associated with entity identifiers of the communication key information. For example, the collated entity information may include details absent from the audio communication, like the address of a potential offender who has fled the crime scene or a criminal record of an entity named in the call. The method may also acquire linked entity information from one or more data sources and provide the linked entity information as part of the communication intelligence data. The linked entity information may comprise collated information relating to a second entity linked to the first entity (e.g. spouse, dependent, parent etc.), where the second entity is not necessarily referenced in the audio communication. For example, dependent information may be relevant for an entity identified in the audio communication to ensure emergency personnel can be dispatched to protect any vulnerable dependents.

In some examples, the method may comprise determining communication intelligence data comprising a threat grade. The threat grade may comprise a score indicating a risk of immediate harm to one or more persons. The threat grade may comprise a standardised scoring system such as the UCR (the Uniform Crime Reporting) scoring or NIBRS (National Incident-Based Reporting System) Scoring.

The method may comprise determining a threat grade based on the one or more danger phrases and/or the event type of the communication key information. The method may comprise determining a threat grade based on whether a situation is ongoing. The method may comprise determining the threat grade based on the collated entity information. For example, a high threat grade may be determined if a danger phrase indicates an immediate risk to an entity e.g. “my ex-husband is outside with a knife” and/or the record data indicates a history of violence.

The method may determine the threat grade using a rules-based approach or a machine learning model. The machine learning model may be trained on historical annotated communication transcripts and optionally associated record data.

### Outputting Communication Intelligence 224

The method may comprise outputting one or more of: the communication transcript; the annotated communication transcript; the communication key information; the one or more entity identifiers; one or more entities associated with the one or more entity identifiers; the one or more danger phrases; the one or more identified relationships between the communication key information; the record data/collated entity information; and the threat grade.

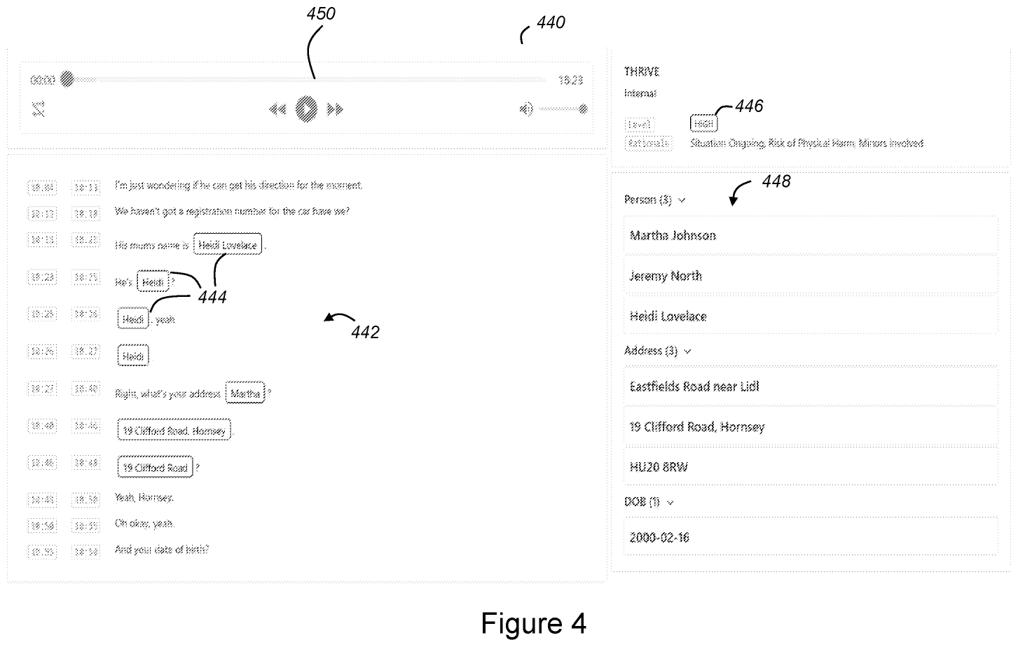

In some examples, the method may comprise outputting the communication intelligence data to a user interface of an electronic device. For example, the communication intelligence data may be presented on a dashboard (e.g. FIG. 4) to an operator (e.g. call handling operator, triage operator, dispatch operator). As noted above the user interface may enable user feedback on the communication intelligence data that can be used to update and improve one or more of the models used in the method. For example, a user may correct a communication transcript, an annotated communication transcript, record data associated with entities, a threat grade or any other communication intelligence data.

In some examples, the method may comprise outputting the communication intelligence data by performing a regulatory action such as the actions listed above for a domestic violence communication.

In some examples, the method may comprise outputting the communication intelligence data to a memory for storage. The method may further comprise generating one or more new records or updating one or more existing records in the one or more data sources and/or record management systems. The records may comprise records for one or more entities identified in the audio communication or a case record for the incident reported in the communication.

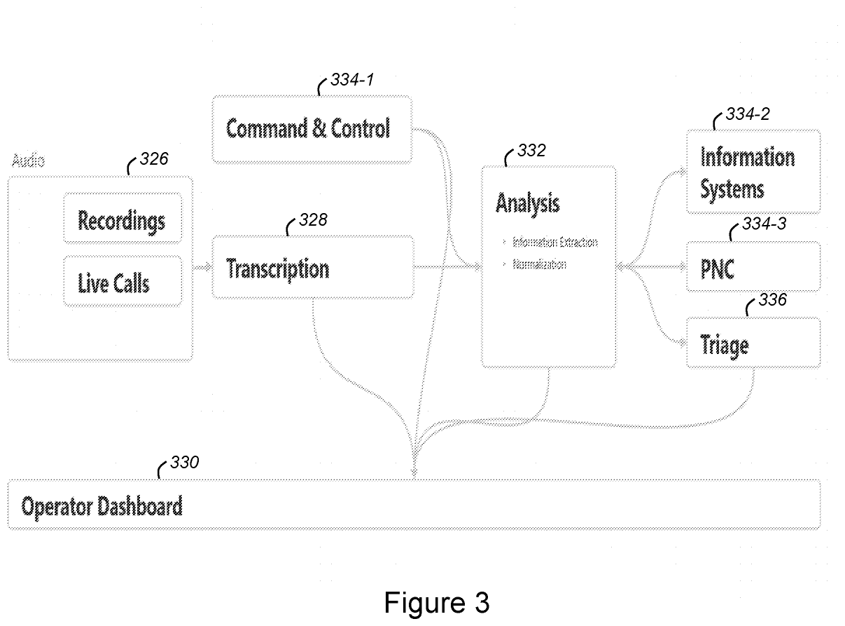

FIG. 3 provides a structural overview of the data flow in an example method of audio communication processing.

A receiver module 326 receives the audio signal which may represent a live or recorded call to a law enforcement service. A transcription module 328 receives the audio signal from the receiver module 326 and processes the audio signal with a speech-to-text model to generate a communication transcript 328. The transcription module 328 may output the communication transcript to an operator dashboard 330.

An analysis module 332 may receive the communication transcript from the transcription module 328 and analyse the communication transcript to identify communication key information. The analysis module 332 may output the communication key information to the operator dashboard, for example by highlighting words or phrases of the communication transcript. The analysis module 332 may also instruct searches of one or more data sources 334-1, 334-2, 334-3 based on the communication key information (e.g. one or more entity identifiers) associate collated entity information (record data) with the communication key information. The analysis module 332 may output the record data to the operator dashboard 330.

The analysis module 332 may further determine communication intelligence data comprising one or more of: one or more relationships between the communication key information; the record data associated with the communication key information; and a threat grade calculated based on the communication key information and optionally the associated record data. The analysis module 332 may output such communication intelligence data to the operator dashboard 332. The analysis module 332 may also output the communication intelligence data to the one or more data sources 334-1, 334-2, 334-3 for generating or updating records and to one or more other operators such as a triage operator 336 or a dispatch operator.

FIG. 4 illustrates an example operator dashboard 440 presenting communication intelligence data from an audio communication according to an embodiment of the present disclosure.

The operator dashboard 440 presents various forms of communication intelligence data. The operator dashboard 440 presents the communication transcript 442. In this example the communication transcript 442 is an annotated communication transcript highlighting the communication key information 444 of the transcribed text. The operator dashboard also includes an interface 450 to playback the audio communication enabling the operator to correct the communication transcript 442 and/or the highlighted communication key information 444 based on re-hearing the audio communication.

The operator dashboard 440 further presents the threat grade 446 in this instance indicating a “High” threat grade and presenting a rationale “Situation ongoing; risk of physical harm.” The operator dashboard 440 further includes a list of entity identifiers 448 relevant to the audio communication. The entity identifiers may relate to entities identified by the entity identifiers 444 of the communication key information or may comprise linked entities identified from the associated record data obtained from the one or more data sources.

The dashboard presents the communication intelligence data in a concise manner enabling the operator to make rapid and informed decisions and optionally ask the caller for relevant further information.

The disclosed systems and methods advantageously analyse communications to emergency services in a rapid, objective and efficient manner providing enhanced communication intelligence data for the operator. The systems and methods can provide an objective assessment of the threat grade and minimise the effects of subjective emotional human assessment. However, the methods allow for human intervention via correction of the communication intelligence data in the event that an operator's emotional intelligence identifies further intelligence or a higher risk than indicated by the threat grade.

The disclosed systems and methods provide an intelligence layer that can tie together disparate systems and data sources used by operators throughout the lifecycle of an incident together. The intelligence layer can act as an assistive and automation tool for the Control Room Operator and as an Intelligence Centre for the Dispatch Room Operators.

The disclosed systems and methods can advantageously:
a. Find all information related to the situation by developing an Incident log
b. Provide operational intelligence (communication intelligence data) at a glance for the operators
c. Display it in an intuitive interface
d. Offload admin work from the operators
e. Learn from user interactions to deliver more intelligent results in the future
f. Enable police officers to make better-informed decisions faster
g. Increase First-Time Resolution (FTR)
h. Increase public safety
i. Increase officer safety
j. Increase time police offices spend policing through decreased time spent on admin
k. Reduce police officer and police staff stress
l. 13. Enable effective safeguarding of children and vulnerable adults
m. 14. Assist in the investigation of incidents and accurate scoring of risk according to standard police scoring methodology.

Although the disclosed systems and methods have been described in relation to the specific example of an audio communication to a law enforcement service, the disclosed methods and systems can be equally applied to non-audio communications (text, social media, online) and to any emergency service more generally. For example, the emergency service may be an ambulance service or a fire service. Appropriate adjustments may be made to the key concepts of: the communication key information (e.g. danger words may be related to health risks, health conditions, symptoms, diagnostic readings or injury (ambulance service) or fire risk (fire service)); and the one or more data sources (e.g. health records (ambulance service) or records of dangerous chemicals or buildings (fire service)). The above described models may be trained with relevant ambulance or fire service training data accordingly. Similar advantages of rapid and objective analysis and presentation of communication intelligence data apply to other emergency services.

The disclosed methods may be performed by one or more processors executing instructions stored on a computer readable medium. The one or more processors may be local to the operator, e.g. at a police station, or remote from the operator for example as part of a networked or cloud computing structure. The one or more processors may communicate with the source of the audio signal and/or the operator dashboards via a communication system such as a telephone network or the internet.

The models described above may comprise an algorithm or a set of instructions that may be carried out by one or more processors. The algorithm or set of instructions may be stored on a computer readable medium. The described models may be combined into a larger model, comprise sub-models of a larger model or may be split into separate models.

1. A computer implemented method of processing a communication to a law enforcement service, the method comprising:
receiving a communication transcript of the communication;
analyzing the communication transcript to identify communication key information;
determining communication intelligence data based on the communication key information; and
outputting the communication intelligence data.

2. The method of claim 1, wherein the communication comprises an audio communication and the method further comprises:
receiving an audio signal of the audio communication; and
processing the audio signal with a speech-to-text model to generate the communication transcript.

3. The method of claim 2, wherein the speech to text model comprises an artificial intelligence model.

4. The method of claim 3, wherein the artificial intelligence model is trained using historical data comprising audio communications to one or more law enforcement services and corresponding communication transcripts.

5. The method of claim 2, further comprising processing the audio signal with the speech-to-text model to generate a communication transcript comprising one or more non-verbal indicators.

6. The method of claim 5, wherein the one or more non-verbal indicators comprise one or more of: stress, fear, nervousness, intoxication, dishonesty, and duress of a voice in the audio communication or background noise in the audio communication.

7. The method of claim 2, further comprising:
outputting the communication transcript as part of the communication intelligence data;
receiving corrections to the communication transcript to generate a corrected communication transcript; and
updating the speech-to-text model using the corrected communication transcript.

8. The method of claim 1, wherein the communication intelligence data comprises a threat grade.

9. The method of claim 8, wherein the communication key information comprises one or more danger phrases and the method further comprises determining the threat grade based on the one or more danger phrases.

10. The method of claim 1, wherein the communication key information comprises one or more entity identifiers.

11. The method of claim 10, wherein the one or more entity identifiers include one or more of: an entity name, an entity address, an entity date of birth, an entity ethnicity, an entity nationality, an entity gender, an entity age, an entity relationship to another entity, an entity health status, an entity appearance description, an entity victim status, and an entity registration.

12. The method of claim 1, further comprising:
identifying one or more relationships between elements of the communication key information; and
determining the communication intelligence data based on the communication key information and the one or more identified relationships;
a relationship between a plurality of entity identifiers;
a relationship between a plurality of entities; or
a relationship between an entity identifier and one or more danger phrases.

13. The method of claim 1, wherein analyzing the communication transcript comprises processing the communication transcript with a natural language processing model, an artificial intelligence model.

14. The method of claim 13, further comprising:
outputting the communication key information as an annotated communication transcript;
receiving corrections to the annotated communication transcript to generate a corrected annotated communication transcript; and
updating the natural language processing model using the corrected annotated communication transcript.

15. The method of claim 1, wherein the communication key information comprises one or more entity identifiers, the method further comprising:
searching one or more data sources and acquiring record data associated with the one or more entity identifiers; and
determining the communication intelligence data based on the communication key information and the record data; and
determining the threat grade based on the communication key information and the record data.

16. The method of claim 15, wherein the one or more data sources comprise one or more of:
one or more law enforcement databases;
one or more other communications to a law enforcement service; and
one or more publicly available data sources comprising news websites, social media posts or social media profiles.

17. The method of claim 15, wherein the one or more data sources comprise a plurality of heterogenous data sources and the method further comprises merging heterogenous source data to provide the record data associated with the one or more entity identifiers.

18. The method of claim 15, further comprising associating the one or more entity identifiers with the record data using one or more matching models.

19. The method of claim 1, further comprising outputting the communication intelligence data to one or more of:
a data source or database;
an operator user interface;
a regulatory module for performing an administrative action.
